(19) United States
(12) Patent Application Publication
(10) Pub. No.: US 2015/0117307 A1
(43) Pub. Date: Apr. 30, 2015

(54) ADJUSTING PHYSICAL RANDOM ACCESS CHANNEL (PRACH) TRANSMISSION POWER

(71) Applicant: QUALCOMM Incorporated, San Diego, CA (US)

(72) Inventors: Ming YANG, San Diego, CA (US); Tom CHIN, San Diego, CA (US); Qingxin CHEN, Del Mar, CA (US); Guangming SHI, San Diego, CA (US)

(73) Assignee: QUALCOMM Incorporated, San Diego, CA (US)

(21) Appl. No.: 14/065,383

(22) Filed: Oct. 28, 2013

(51) Int. Cl. H04W 52/24

(52) U.S. Cl. CPC H04W 52/245
USPC 370/328

(57) ABSTRACT

A method of wireless communication includes modifying an initial transmit power for a subsequent uplink physical channel based on the difference between the desired received powers of the subsequent uplink physical channel and a random access physical channel. When the difference between the desired power of the subsequent uplink physical channel and the random access physical channel is above a predefined threshold, the modification is based on a first adjusted factor. When the subsequent uplink physical channel and random access physical channel are on different frequencies (or time slots) the modification is based on a second adjusted factor.

### BACKGROUND

1. Field

Aspects of the present disclosure relate generally to wireless communication systems, and more particularly, to adjusting the physical random access channel (PRACH) transmission power in a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication is disclosed. The method includes modifying an initial transmit power for a subsequent uplink physical channel based at least in part on a difference between desired received powers of the subsequent uplink physical channel and a random access physical channel.

Another aspect is directed to a method of wireless communication and includes configuring a desired received power based on a path loss or interference difference, where the difference results from a frequency difference or time slot difference between a random access channel and a subsequent uplink physical channel.

In another aspect, a wireless communication having a memory and at least one processor coupled to the memory is disclosed. The processor(s) is configured to modify an initial transmit power for a subsequent uplink physical channel based at least in part on a difference between desired received powers of the subsequent uplink physical channel and a random access physical channel.

Another aspect discloses a wireless communication having a memory and at least one processor coupled to the memory. The processor(s) is configured to determine a desired received power based on a path loss difference, where the difference results from a frequency difference or time slot difference between a random access channel and a subsequent uplink physical channel.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of modifying an initial transmit power for a subsequent uplink physical channel based at least in part on a difference between desired received powers of the subsequent uplink physical channel and a random access physical channel. The program code also causes the processor(s) to communicate according to the modified transmit power.

Another aspect discloses a computer program product for wireless communications in a wireless network having a non-transitory computer-readable medium. The computer readable medium has non-transitory program code recorded thereon which, when executed by the processor(s), causes the processor(s) to perform operations of configuring a desired received power based on a path loss or interference difference, where the difference results from a frequency difference or time slot difference between a random access channel and a subsequent uplink physical channel. The program code also causes the processor(s) to communicate the desired received power.

In another aspect, an apparatus for wireless communications is disclosed and includes a means for modifying an initial transmit power for a subsequent uplink physical channel based at least in part on a difference between desired received powers of the subsequent uplink physical channel and a random access physical channel. Also included is a means for communicating according to the modified transmit power.

Another aspect discloses an apparatus for wireless communications and includes a means for configuring a desired received power based on a path loss or interference difference, where the difference results from a frequency difference or time slot difference between a random access channel and a subsequent uplink physical channel. Also included is a means for communicating the desired received power.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is an example flow diagram illustrating the modification of an initial transmit power according to aspects of the present disclosure.

FIG. 5 is a block diagram illustrating a method for modifying an initial transmit power according to one aspect of the present disclosure.

FIG. 6 is a diagram illustrating an example of a hardware implementation for an apparatus employing a processing system according to one aspect of the present disclosure.

FIG. 7 is a block diagram illustrating a method for configuring a desired received power according to one aspect of the present disclosure.

FIG. 8 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

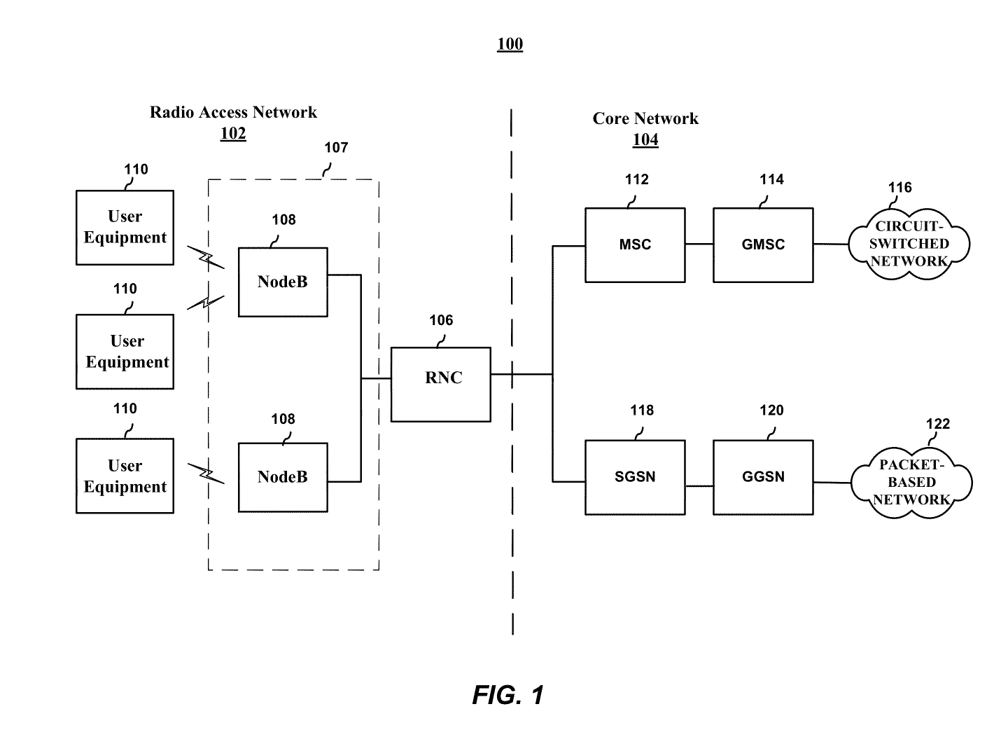

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

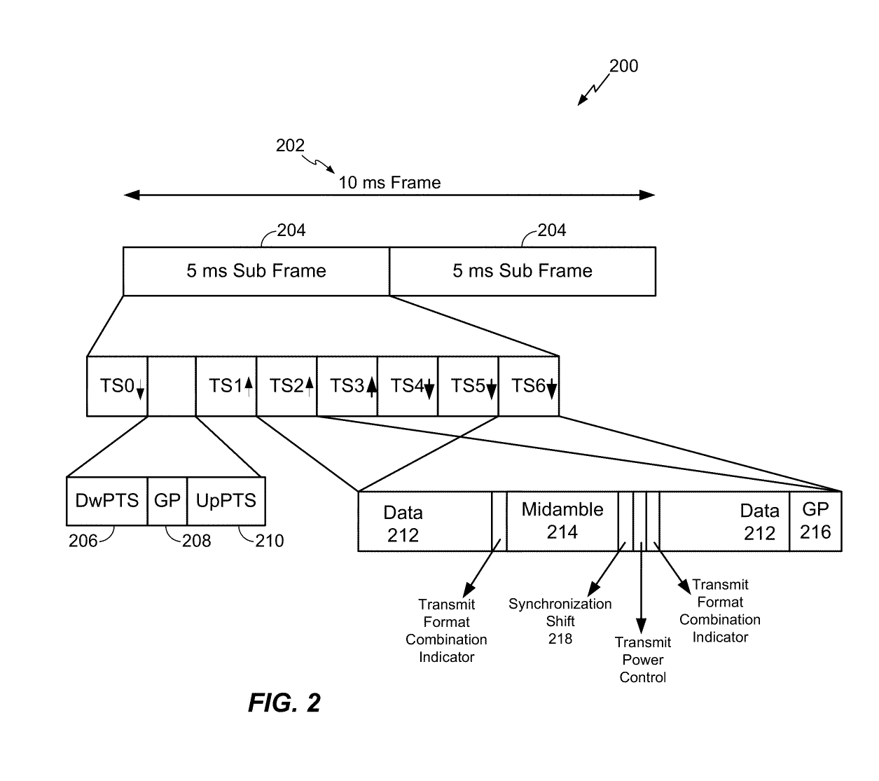

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. Typically, the seven time slots (i.e., TS0-TS6) are allocated for regular traffic and signaling. In particular, the first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206 (also known as the downlink pilot channel), a guard period (GP) 208, and an uplink pilot time slot (UpPTS) 210 (also known as the uplink pilot channel (UpPCH)) are located between TS0 and TS1. The downlink pilot channel (DwPCH) 206 is used to transmit a pilot signal for a cell. The uplink pilot channel (UpPCH) 210 can be used by the UE for performing an initial random access procedure and uplink synchronization in a handover. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

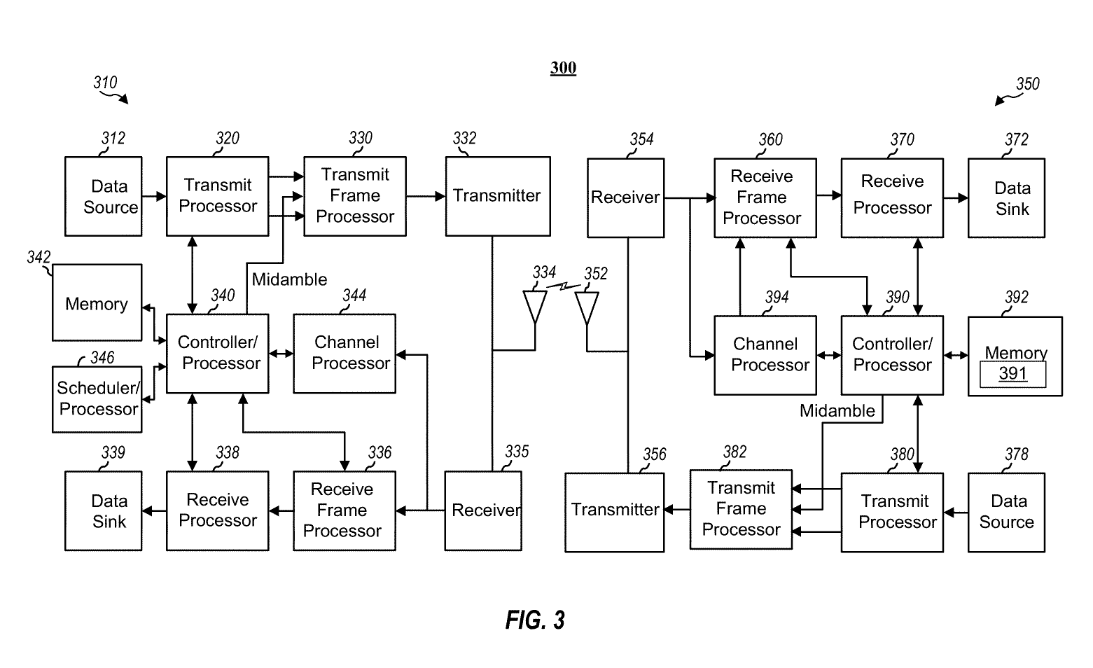

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a transmit power module 391 which, when executed by the controller/processor 390, configures the UE 350 for modifying an initial transmit power. Additionally, the memory 342 of the node B 310 may store a desired received power module 341 which, when executed by the controller/processor 340, configures the node B 340 for configuring a desired received power.

Current physical random access channel (PRACH) transmission power is derived based on the uplink physical channel (UpPCH) where there is no power control on the PRACH. In particular, in TD-SCDMA, before a UE sends the physical random access channel (PRACH), the UE may perform a random access procedure. The random access procedure is a probing-type process and is described as follows. First, the UE randomly selects an uplink physical channel (UpPCH) and one uplink synchronization (SYNC-UL) sequence, respectively. The UE transmits the SYNC-UL sequence on the UpPCH or another uplink access position indicated by higher layers. After sending the SYNC-UL sequence, the UE listens to the relevant fast physical access channel (FPACH) for a predetermined number of subframes (wait time (WT)) to receive the network acknowledgement. If no valid answer is detected within the wait time period, the UpPCH transmission power (ΔP0) is increased as follows:

ΔP0=Power Ramp Step [dB].

If the UE reaches a maximum allowed UpPCH re-transmissions, the UE reports a random access failure. The UpPCH transmission power (P_{UpPCH}) is given by the following equation:

P_{UpPCH}=L_{PCCPCH}PRX_{UpPCH,des}(i−1)*PWrᵣₐₘₚ

where P_{UpPCH} is the transmission power on the UpPCH;

L_{PCCPCH} is the estimated path loss based on the received P_{CCPCH} power;

PRX_{UpPCH,des} is the Node B expected (or desired) receive power;

Pwrᵣₐₘₚ is the power ramp step, and

the variable “i” corresponds to the number of transmitted SYNC-UL sequences (e.g., i=1 for the 1^{st} transmitted SYNC-UL sequence; i=2 for the 2^{nd} transmitted SYNC-UL sequence, etc).

The L_{PCCPCH} (i.e., the estimated path loss based on the received PCCPCH power) may be calculated based on the following, where: L_{PCCPCH}=the transmit (Tx) power of the primary common control physical channel (PCCPCH) signaled on a broadcast channel (BCH)-UE received signal code power (RSCP) for the PCCPCH).

When a valid answer is detected within the defined wait time period, the UE sends the PRACH using the power indicated by the fast physical access channel (FPACH).

In the 3rd Generation Partnership Project (3GPP) TS 25.224 specification, the FPACH carries a transmit power level command for the PRACH. The transmit power level command field indicates, to the user equipment, the power level to use for the RACH message transmission on the FPACH associated PRACH. The network may set this power level based on a measured interference level (I) (in dBm) on a specific PRACH and/or based on a desired signal to interference ratio (SIR) (in dB) on this channel. The transmit power level command for the PRACH is represented by PRACH (PRX_{PRACH,des}), where PRX_{PRACH,des} is the desired receive power level on the PRACH. The UE adds the estimated path loss to the PRX_{PRACH,des} value, to compute the power level for transmitting the PRACH. The power level for transmitting the PRACH is given by the following equation:

P_{PRACH}=L_{PCCPCH}+PRX_{PRACH,des}+(i_{UpPCH}−1)*PWrᵣₐₘₚ

where P_{PRACH} is the power level to transmit on the PRACH; and

i_{UpPCH} is the final value of i.

In the above calculations, the path loss is a function of frequency. For example, the higher the frequency, the higher the path loss for the same direction. Similarly, the lower the frequency, the lower the path loss for the same direction.

Unlike WCDMA, UpPCH and PRACH may be on the different time slots, or different frequencies, which may have different uplink interference levels and different path loss. When there are different interference levels and/or path loss between UpPCH and PRACH, the PRACH transmission power is based on the accumulated UpPCH power ramp plus path loss (which may be erroneous). This may result in failure of the PRACH to reach the network. In this case, the UE performs the random access process again to re-transmit the PRACH, which increases the time for the call setup or hard handover latency. In some cases, the error causes call setup failure or hard handover failure when the PRACH transmission power is not sufficient.

The UpPCH is transmitted on a primary frequency, while the PRACH may be transmitted on the primary frequency or a second frequency for different path loss. Because the different frequencies have difference measured path loss, the PRACH transmission power should be corrected when UpPCH and PRACH are on the different frequencies.

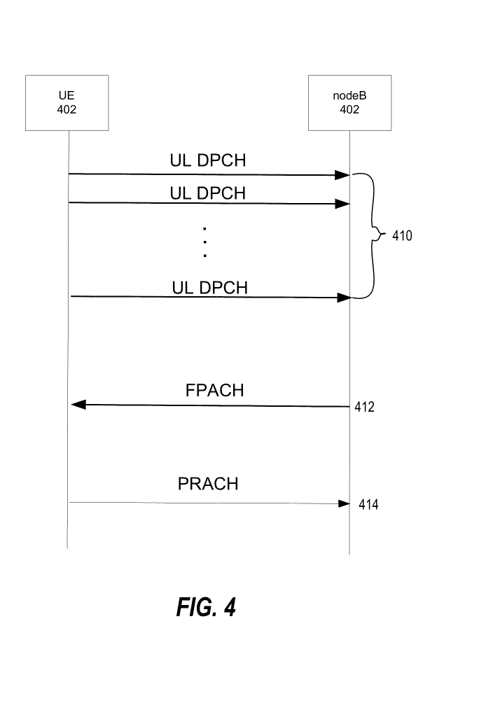

Some aspects of the present disclosure are directed to modifying the initial transmit power (e.g., PRACH transmission power). FIG. 4 is a call flow diagram of communications between a UE 402 and nodeB 404 and illustrates an example modification of the initial transmit power in. During time 410, the UE 402 chooses and transmits one of 8 SYNC-UL sequences on the UpPCH. The UE 402 waits for predefined time period (i.e., the wait time (WT)) to receive FPACH from the NodeB 404. The FPACH carries the transmit power level command for PRACH. In one example, the WT is 4 subframes. If the UE 402 does not receive FPACH within the predefined wait time period, then the UE chooses and sends another one of 8 SYNC-UL on the UpPCH.

At time 412, the UE 402 receives FPACH. Then, at time 404, the UE 402 sends PRACH with a modified power. In particular, two types of adjustment that may be applied to the PRACH transmission power. For example, in one aspect, when the difference between the desired receive power for UpPCH (PRX_{UpPCH,des}) and the desired receive power for PRACH (PRX_{PRACH,des}) is above a predefined threshold, the UE sends PRACH with a first adjusted factor. The first adjusted factor is based on the difference in value between PRX_{UpPCH,des} and PRX_{PRACH,des}.

If the PRACH and UpPCH are on different frequencies (or different time slots), the UE sends the PRACH with a second adjusted factor. The second adjusted factor compensates for the difference in frequencies and is based on the path loss difference due to the different frequency (or time slots). Either both or one of the adjusted factors may be applied. The aspects of the present disclosure assist the UE in sending the PRACH with sufficient power, which reduces call setup or hard handover latency. Further, aspects of the present disclosure reduce call setup failure or hard handover failure.

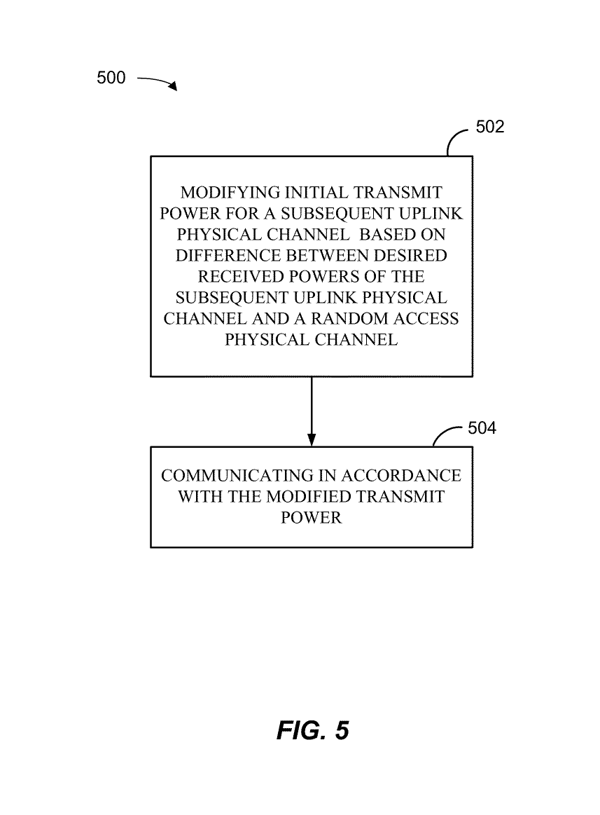

FIG. 5 shows a wireless communication method 500 according to one aspect of the disclosure. In block 502, a UE modifies an initial transmit power for a subsequent uplink physical channel based on a difference between desired received powers of the subsequent uplink physical channel and a random access physical channel. Next, in block 504, the UE communicates according to the modified transmit power.

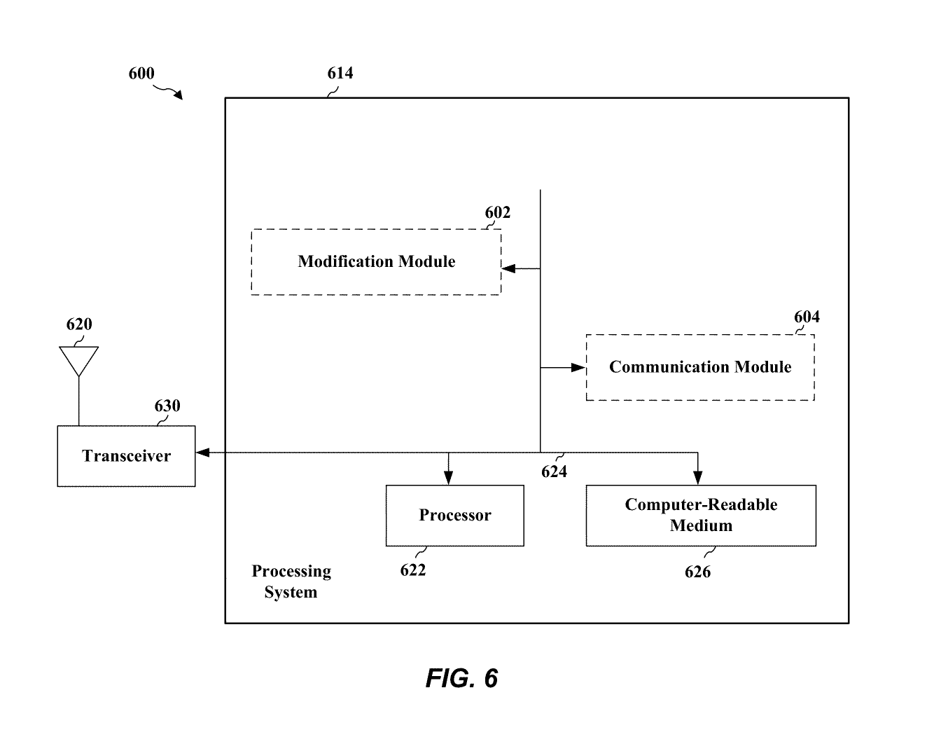

FIG. 6 is a diagram illustrating an example of a hardware implementation for an apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 622 the modules 602, 604, and the non-transitory computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a transceiver 630. The transceiver 630 is coupled to one or more antennas 620. The transceiver 630 enables communicating with various other apparatus over a transmission medium. The processing system 614 includes a processor 622 coupled to a non-transitory computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 includes a modification module 602 for modifying the initial transmit power. The processing system 614 includes a communication module 604 for communicating in accordance with the modification. The modules may be software modules running in the processor 622, resident/stored in the computer readable medium 626, one or more hardware modules coupled to the processor 622, or some combination thereof. The processing system 614 may be a component of the UE 350 and may include the memory 392 and/or the controller/processor 390.

In one configuration, an apparatus such as a UE is configured for wireless communication including means for modifying. In one aspect, the modifying means may be the controller/processor 390, the memory 392, transmit power module 391, modification module 602, and/or the processing system 614 configured to perform the modifying means. The UE is also configured to include means for communicating. In one aspect, the communicating means may be the antennas 352, the receiver 354, the channel processor 394, the receive frame processor 360, the receive processor 370, the transmitter 356, the transmit frame processor 382, the transmit processor 380, the controller/processor 390, the memory 392, transmit power module 391, communication module 604 and/or the processing system 614 configured to perform the communicating means. In one aspect the means functions recited by the aforementioned means. In another aspect, the aforementioned means may be a module or any apparatus configured to perform the functions recited by the aforementioned means.

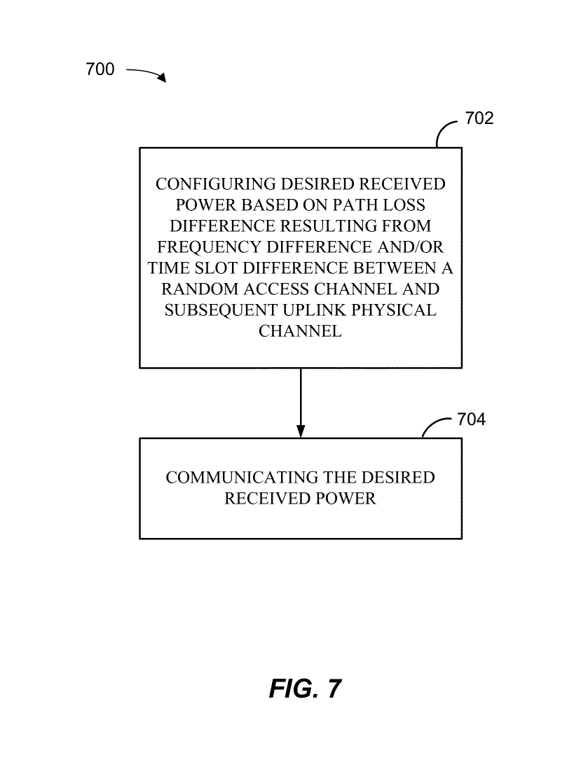

FIG. 7 shows a wireless communication method 700 according to one aspect of the disclosure. In block 702, an eNode configures a desired received power based on a path loss difference resulting from a frequency difference and/or time slot difference between a random access channel and a subsequent uplink physical channel. Next, in block 704, the eNodeB communicates the desired received power.

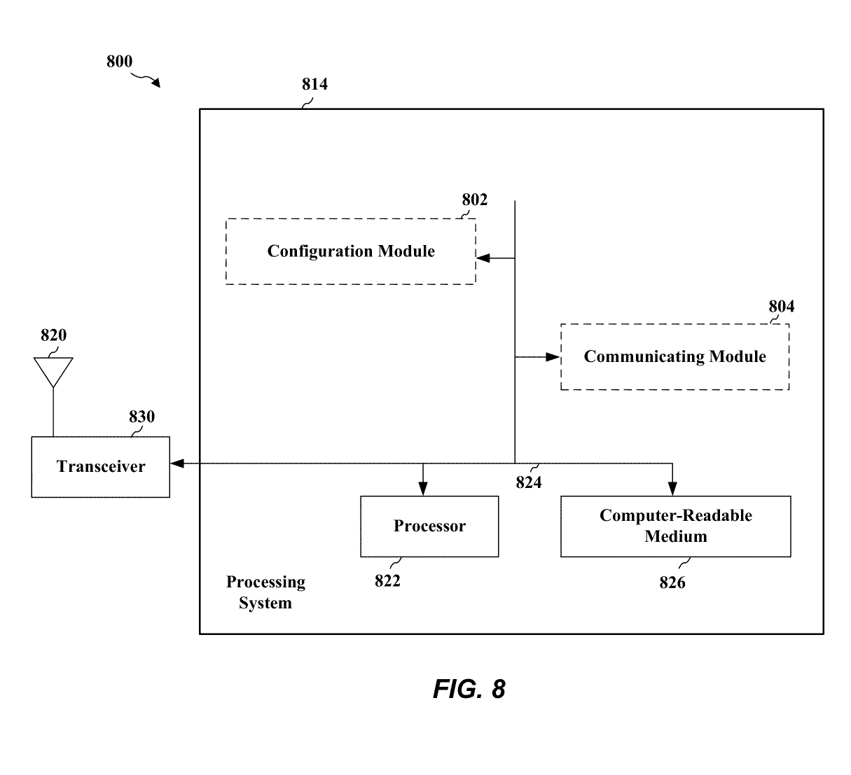

FIG. 8 is a diagram illustrating an example of a hardware implementation for an apparatus 800 employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822 the modules 802, 804, and the non-transitory computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a non-transitory computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a configuration module 802 for configuring the desired received power. The processing system 814 includes a communication module 804 for communicating the desired received power. The modules may be software modules running in the processor 822, resident/stored in the computer readable medium 826, one or more hardware modules coupled to the processor 822, or some combination thereof. The processing system 814 may be a component of the eNodeB 310 and may include the memory 342, and/or the controller/processor 340.

In one configuration, an apparatus such as an eNodeB is configured for wireless communication including means for configuring. In one aspect, the configuring means may be the controller/processor 340, the memory 342, transmit power module 391, module 802, and/or the processing system 814 configured to perform the configuring means. The eNode B is also configured to include means for communicating. In one aspect, the communicating means may be the antennas 334, the receiver 335, the channel processor 344, the receive frame processor 336, the receive processor 338, the transmitter 332, the transmit frame processor 330, the transmit processor 320, the controller/processor 340, the memory 342, transmit power module 391, communication module 804 and/or the processing system 814 configured to perform the communicating means. In one aspect the means functions recited by the aforementioned means. In another aspect, the aforementioned means may be a module or any apparatus configured to perform the functions recited by the aforementioned means.

Several aspects of a telecommunications system has been presented with reference to TD-SCDMA. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
modifying an initial transmit power for a subsequent uplink physical channel based at least in part on a difference between desired received powers of the subsequent uplink physical channel and a random access physical channel.

2. The method of claim 1, further comprising modifying the initial transmit power based on a path loss difference resulting from a frequency difference of the random access physical channel and the subsequent uplink physical channel.

3. The method of claim 1, further comprising modifying the initial transmit power based on an interference difference resulting from a time slot difference of the random access physical channel and the subsequent uplink physical channel.

4. The method of claim 1, in which the modifying occurs when the difference exceeds a predefined threshold value.

5. The method of claim 1, in which the random access physical channel is an uplink pilot channel.

6. The method of claim 1, in which the subsequent uplink physical channel is one of a physical random access channel (PRACH), E-DCH-Random Uplink Control Channel (E-RUCCH), dedicated physical channel (DPCH), or physical uplink shared channel (PUSCH).

7. The method of claim 1, further comprising stopping the modification of the initial transmit power when a fast physical access channel is received.

8. A method of wireless communication, comprising:
configuring a desired received power based on a path loss or interference difference resulting from at least one of a frequency difference or time slot difference between a random access channel and a subsequent uplink physical channel.

9. The method of claim 8, in which the random access physical channel is an uplink pilot channel.

10. The method of claim 8, in which the subsequent uplink physical channel is one of a physical random access channel (PRACH), E-DCH-Random Uplink Control Channel (E-RUCCH), dedicated physical channel (DPCH), or physical uplink shared channel (PUSCH).

11. An apparatus for wireless communication, comprising:
a memory; and
at least one processor coupled to the memory, the at least one processor being configured:
to modify an initial transmit power for a subsequent uplink physical channel based at least in part on a difference between desired received powers of the subsequent uplink physical channel and a random access physical channel.

12. The apparatus of claim 11, in which the at least one processor is further configured to modify the initial transmit power based on a path loss difference resulting from a frequency difference of the random access physical channel and the subsequent uplink physical channel.

13. The apparatus of claim 11, in which the at least one processor is further configured to modify the initial transmit power based on an interference difference resulting from a time slot difference of the random access physical channel and the subsequent uplink physical channel.

14. The apparatus of claim 11, in which the at least one processor is configured to modify when the difference exceeds a predefined threshold value.

15. The apparatus of claim 11, in which the random access physical channel is an uplink pilot channel.

16. The apparatus of claim 11, in which the subsequent uplink physical channel is one of a physical random access channel (PRACH), E-DCH-Random Uplink Control Channel (E-RUCCH), dedicated physical channel (DPCH), or physical uplink shared channel (PUSCH).

17. The apparatus of claim 11, in which the at least one processor is further configured to stop modifying the initial transmit power when a fast physical access channel is received.

18. An apparatus for wireless communication, comprising:
a memory; and
at least one processor coupled to the memory, the at least one processor being configured:
to determine a desired received power based on a path loss or interference difference resulting from at least one of a frequency difference or time slot difference between a random access channel and a subsequent uplink physical channel.

19. The apparatus of claim 18, in which the random access physical channel is an uplink pilot channel.

20. The apparatus of claim 18, in which the subsequent uplink physical channel is one of a physical random access channel (PRACH), E-DCH-Random Uplink Control Channel (E-RUCCH), dedicated physical channel (DPCH), or physical uplink shared channel (PUSCH).
